(19) United States
(12) Patent Application Publication
(10) Pub. No.: US 2014/0310093 A1
(43) Pub. Date: Oct. 16, 2014

(54) DYNAMIC REALLOCATION OF CONTENT ITEM BLOCKS

(71) Applicant: Google Inc., Mountain View, CA (US)

(72) Inventors: Patrick Hummel, Cupertino, CA (US); Joshua V. Dillon, Sunnyvale, CA (US); Christopher K. Harris, Santa Clara, CA (US); Timothy S. Lipus, Sunnyvale, CA (US)

(73) Assignee: Google Inc., Mountain View, CA (US)

(21) Appl. No.: 13/861,062

(22) Filed: Apr. 11, 2013

(51) Int. Cl. G06Q 30/02

(52) U.S. Cl. CPC G06Q 30/0246
USPC 705/14.45

(57) ABSTRACT

Methods, systems, and apparatus include computer programs encoded on a computer-readable storage medium, including a method for providing content. The method includes receiving a request for content for a block and determining a variable number of content items to be responsive to the request, including determining an efficiency for each of a number of permutations of allocations of eligible content items. The efficiency is a summation of individual values associated with content sponsors proposed to be included in the block for a given permutation. A price is established to be charged to each content sponsor associated with a permutation having a highest efficiency. The establishing includes, for each position in a determined highest efficiency permutation: determining a total increase of efficiency associated with all other content sponsors when removing a content sponsor associated with a given position. The eligible content items associated with the determined permutation are provided.

### BACKGROUND

This specification relates to information presentation.

The Internet provides access to a wide variety of resources. For example, video and/or audio files, as well as webpages for particular subjects or particular news articles, are accessible over the Internet. Access to these resources presents opportunities for other content (e.g., advertisements) to be provided with the resources. For example, a webpage can include slots in which content can be presented. These slots can be defined in the webpage or defined for presentation with a webpage, for example, along with search results.

Content slots can be allocated to content sponsors as part of a reservation system, or in an auction. For example, content sponsors can provide bids specifying amounts that the sponsors are respectively willing to pay for presentation of their content. In turn, an auction can be run, and the slots can be allocated to sponsors according, among other things, to their bids and/or the relevance of the sponsored content to content presented on a page hosting the slot or a request that is received for the sponsored content. The content can then be provided to the user on any devices associated with the user such as a personal computer (PC), a smartphone, a laptop computer, a tablet computer, or some other user device.

### SUMMARY

In general, one innovative aspect of the subject matter described in this specification can be implemented in methods that include a computer-implemented method for providing content. The method includes receiving a request for content to fill a block, the request including information about a size of the block and selection criteria for identifying one or more eligible content items for inclusion in the block. The method further includes determining a variable number of content items to be included in the block, including determining an efficiency for each of a number of permutations of allocations of eligible content items, wherein the efficiency is a summation of individual values associated with content sponsors that are proposed to be included in the block for a given permutation, and wherein a given individual value is based on a combination of a bid price and a quality score associated with a respective individual eligible content item when included in the block. The method further includes establishing a price to be charged to each content sponsor associated with a permutation that has a highest efficiency based on the determining. The establishing includes, for each position in a determined highest efficiency permutation: determining a total increase of efficiency associated with all other content sponsors when removing a content sponsor associated with a given position, the total increase of efficiency being based on content items excluding the content item associated with the excluded content sponsor; determining a highest efficiency from among the total efficiencies determined; and establishing a price for each position based on the determined increase in efficiency. The method further includes providing the eligible content items associated with the determined permutation responsive to the request and charging the content sponsors based on the established prices.

These and other implementations can each optionally include one or more of the following features. Determining a total increase in efficiency can further include: determining an efficiency of the determined permutation without a respective content sponsor that is associated with a given position; determining a counterfactual efficiency equal to the highest efficiency permutation that removes a respective eligible content item from the block; and combining the determined efficiency and the determined counterfactual efficiency. Combining can include subtracting the determined efficiency from the determined counterfactual efficiency. Determining an efficiency of the determined permutation can include removing a contribution in an efficiency calculation for a respective eligible content item that is associated with a given position of the block. The eligible content items can be advertisements. The method can further include dynamically re-sizing the eligible content items that are associated with the determined highest efficiency permutation based at least in part on a value to a respective sponsor for inclusion of their content item in the block.

The method can further include determining a reserve price that is associated with the block for any content items that are to be included in the block and using the reserve price in establishing the price. Establishing the price can include using the reserve price as a floor when calculating efficiency for the highest efficiency permutation. Using the reserve price as a floor can include using the reserve price instead of a bid price when the bid price is less than the reserve price for a given eligible content item. Establishing a price can further include dividing the highest efficiency by a quality score associated with a respective eligible content item that is proposed to be presented in a given position. The quality score can include a measure of predicted performance for a given eligible content item when presented in a position included in the block. The method can include a mechanism for providing a total of k eligible content items in the block, the efficiency for a given permutation is given by:

Σⱼ₌₁^{k}x_{j,k}v₍ⱼ₎

and wherein the pricing for a given j^{th} position is given by:

$$\frac{1}{{q}_{( j )} {x}_{j , k}} ( {S}_{j , K} - {R}_{j , k} )$$

wherein:

K is a maximum number of eligible content items displayable on a publisher's site;

bᵢ is a bid placed by a content sponsor i;

qᵢ is a quality score of content sponsor i;

q₍ⱼ₎ is a quality score of the eligible content item in the j^{th} position;

S_{j,K}≡max_{kε[1,K]}Σᵢ₌₁^{j-1}x_{i,k}v₍ᵢ₎+Σᵢ₌ⱼ^{K}x_{i,k}v₍ᵢ₊₁₎, wherein x_{j,k} represents a measure of a relative number of interactions a content item will receive in position j when there are a total of k content items in the block, wherein x_{j,k} is non-increasing in j for all k, and wherein x_{j,k}=0 for all j>k and all k>a;

v₍ⱼ₎ is the j^{th} highest value of bᵢqᵢ for all j≦a, wherein vⱼ=0 for all j>a;

a is a number of content sponsors submitting bids in an auction;

k is a positive integer in [1,K] that has the highest value of Σᵢ₌ⱼ^{k}x_{j,k}v₍ⱼ₎;

j is a position value for which the mechanism is to decide to provide the eligible content item with the j^{th} highest value of bᵢqᵢ in the j^{th} highest of available positions; and:

R_{j,k}≡Σ_{i≠j}x_{i,k}v₍ᵢ₎.

In general, another innovative aspect of the subject matter described in this specification can be implemented in computer program products that include a computer program product tangibly embodied in a computer-readable storage device and comprising instructions. The instructions, when executed by one or more processors, cause the processor to: receive a request for content to fill a block, the request including information about a size of the block and selection criteria for identifying one or more eligible content items for inclusion in the block; determine a variable number of content items to be included in the block, including determining an efficiency for each of a number of permutations of allocations of eligible content items, wherein the efficiency is a summation of individual values associated with content sponsors that are proposed to be included in the block for a given permutation, and wherein a given individual value is based on a combination of a bid price and a quality score associated with a respective individual eligible content item when included in the block; establish a price to be charged to each content sponsor associated with a permutation that has a highest efficiency based on the determining, the establishing including, for each position in a determined highest efficiency permutation: determine a total increase of efficiency associated with all other content sponsors when removing a content sponsor associated with a given position, the total increase of efficiency being based on content items excluding the content item associated with the excluded content sponsor; determine a highest efficiency from among the total efficiencies determined; and establish a price for each position based on the determined increase in efficiency; and provide the eligible content items associated with the determined permutation responsive to the request and charging the content sponsors based on the established prices.

These and other implementations can each optionally include one or more of the following features. The eligible content items can be advertisements. The computer program product can further include instructions, that when executed, cause the one or more processors to dynamically re-size the eligible content items that are associated with the determined highest efficiency permutation based at least in part on a value to a respective sponsor for inclusion of their content item in the block. The computer program product can further include instructions, that when executed, cause the one or more processors to determine a reserve price that is associated with the block for any content items that are to be included in the block and use the reserve price in establishing the price.

In general, another innovative aspect of the subject matter described in this specification can be implemented in systems, including a system comprising one or more processors and one or more memory elements including instructions. The instructions, when executed, cause the one or more processors to: receive a request for content to fill a block, the request including information about a size of the block and selection criteria for identifying one or more eligible content items for inclusion in the block; determine a variable number of content items to be included in the block, including determining an efficiency for each of a number of permutations of allocations of eligible content items, wherein the efficiency is a summation of individual values associated with content sponsors that are proposed to be included in the block for a given permutation, and wherein a given individual value is based on a combination of a bid price and a quality score associated with a respective individual eligible content item when included in the block; establish a price to be charged to each content sponsor associated with a permutation that has a highest efficiency based on the determining, the establishing including, for each position in a determined highest efficiency permutation: determine a total increase of efficiency associated with all other content sponsors when removing a content sponsor associated with a given position, the total increase of efficiency being based on content items excluding the content item associated with the excluded content sponsor; determine a highest efficiency from among the total efficiencies determined; and establish a price for each position based on the determined increase in efficiency; and provide the eligible content items associated with the determined permutation responsive to the request and charging the content sponsors based on the established prices.

The eligible content items can be advertisements. The system can further include instructions that, when executed, cause the one or more processors to dynamically re-size the eligible content items that are associated with the determined highest efficiency permutation based at least in part on a value to a respective sponsor for inclusion of their content item in the block. The system can further include instructions that, when executed, cause the one or more processors to determine a reserve price that is associated with the block for any content items that are to be included in the block and use the reserve price in establishing the price.

Particular implementations may realize none, one or more of the following advantages. Content sponsors can be encouraged to place bids for the selection of their sponsored content items based on their true value per click. Auctions for selecting among eligible content items can allow for the selection of a variable number of content items to fill a block. Dynamic resizing of individual content items can be used in association with the selection of a variable number of content items (e.g., so as to fill the available block space). The number of content items that get displayed can affect the size and the prominence of the content items that are shown, thus affecting the click-through rates of the content items, even if each content item's relative position on a page remains unchanged.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for delivering content.

FIG. 2 is a flowchart of an example process for providing dynamic content generated from social network webpages.

FIG. 3 is a block diagram of an example computer system that can be used to implement the methods, systems and processes described in this disclosure.

Like reference numbers and designations in the various drawings indicate like elements.

### DETAILED DESCRIPTION

This document describes systems, methods, computer program products and apparatus for the selection of content items responsive to requests to fill a content block. The system provides incentives for “truthful” bids by content sponsors (i.e., bids that reflect a true value to the bidder), and supports dynamic resizing of content items based on the number of content items that are selected to be included in a given block. In some implementations, publishers can be allowed to specify minimum prices for the presentation of content items (e.g., advertisements) on/in their publications (e.g., on their web pages). As will be described in more detail below, the systems, methods and mechanisms described here can be used in association with conventional auctions or auctions that have reserve prices.

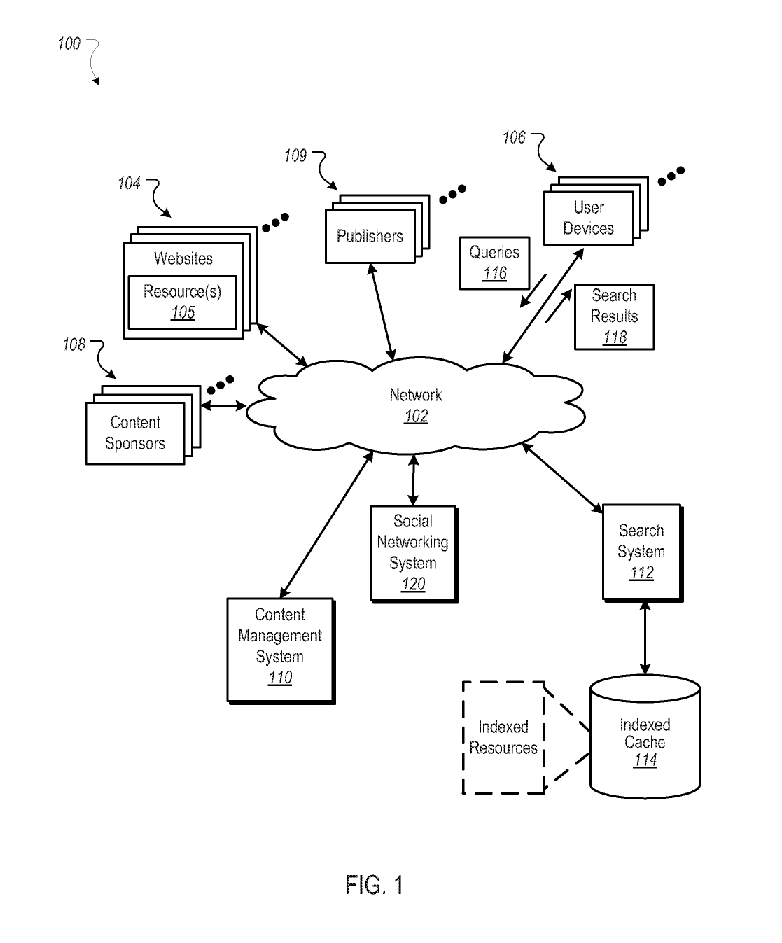

FIG. 1 is a block diagram of an example environment 100 for delivering content. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices 106, content sponsors 108 (e.g., advertisers), publishers 109, the content management system 110 and, in this example, a social networking system 120. The example environment 100 may include many thousands of websites 104, user devices 106, content sponsors 108 and publishers 109.

A website 104 includes one or more resources 105 associated with a domain name and hosted by one or more servers. An example website is a collection of webpages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript™ scripts).

A user device 106 is an electronic device that is under control of a user and is capable of requesting and receiving resources over the network 102. Example user devices 106 include personal computers (PCs), televisions with one or more processors embedded therein or coupled thereto, set-top boxes, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or webpage, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 can, for example, access the indexed cache 114 to identify resources that are relevant to the search query 116. The search system 112 identifies the resources in the form of search results 118 and returns the search results 118 to the user devices 106 in search results pages. A search result 118 can be data generated by the search system 112 that identifies a resource that is provided in response to a particular search query, and includes a link to the resource. In some implementations, the search results 118 include the content itself, such as a map, or an answer, such as in response to a query for a store's products, phone number, address or hours of operation. In some implementations, the content management system 110 can generate search results 118 using information (e.g., identified resources) received from the search system 112. An example search result 118 can include a webpage title, a snippet of text or a portion of an image extracted from the webpage, and the URL of the webpage. Search results pages can also include one or more slots in which other content items (e.g., ads) can be presented.

In some implementations, slots on search results pages or other webpages can include content slots for content items that have been provided as part of a reservation process. In a reservation process, a publisher and a content item sponsor enter into an agreement where the publisher agrees to publish a given content item (or campaign) in accordance with a schedule (e.g., provide 1000 impressions by date X) or other publication criteria. In some implementations, content items that are selected to fill the requests for content slots can be selected based, at least in part, on priorities associated with a reservation process (e.g., based on urgency to fulfill a reservation).

When a resource 105, search results 118 and/or other content are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110 in association with a given request. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. In some implementations, the selection of the eligible content items can further depend on user signals, such as demographic signals and behavioral signals.

The content management system 110 can select from the eligible content items that are to be provided for presentation in slots of a resource or search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations). The offers represent the amounts that the content sponsors are willing to pay for presentation (or selection or other interaction with) of their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, and/or other factors. Exactly how many content items to include in a block and the sizing/re-sizing of selected items are discussed in greater detail below.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a webpage, and consummates a purchase there before leaving that webpage. A conversion can also be defined by a content provider to be any measurable or observable user action, such as downloading a white paper, navigating to at least a given depth of a website, viewing at least a certain number of webpages, spending at least a predetermined amount of time on a web site or webpage, registering on a website, experiencing media, or performing a social action regarding a content item (e.g., an ad), such as republishing or sharing the content item. Other actions that constitute a conversion can also be used.

For situations in which the systems discussed here collect and/or use personal information about users, the users may be provided with an opportunity to enable/disable or control programs or features that may collect and/or use personal information (e.g., information about a user's social network, social actions or activities, a user's preferences or a user's current location). In addition, certain data may be anonymized in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

In some implementations, content items (e.g., advertisements) can be selected by the content management system 110 using various techniques for dynamically allocating content items to blocks, as will be described in greater detail below. For example, in response to a request to fill a content item slot, the content management system 110 can select one or more content items, e.g., that that best satisfy the request. In some implementations, the selection process can include the use of mathematical and other techniques to determine efficiencies associated with different permutations of content items that are eligible to fill a slot. The selection of one or more content items from among eligible content items can be based on counterfactual efficiencies associated with a given permutation. Counterfactual efficiencies are discussed in greater detail below.

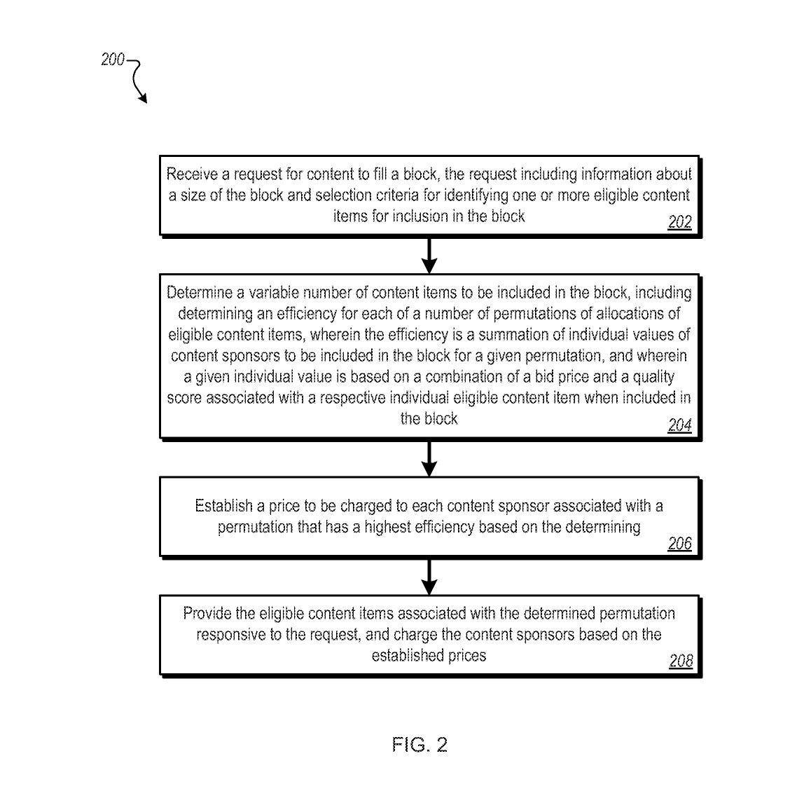

FIG. 2 is a flowchart of an example process 200 for dynamically allocating content items in a block. In some implementations, the content management system 110 can perform steps of the process 200 using instructions that are executed by one or more processors. FIG. 1 is used to provide example structures for performing the steps of the process 200.

A request for content to fill a block is received (202). In some implementations, the request includes information about a size of the block and selection criteria for identifying one or more eligible content items for inclusion in the block. For example, the content management system 110 can receive a request for content from the user device 106. The request, e.g., can be for one or more content items (e.g., advertisements) to fill a content item slot (e.g., an advertisement slot on a web page).

A variable number of content items to be included in the block are determined, including determining an efficiency for each of a number of permutations of allocations of eligible content items (204). In some implementations, the efficiency is a summation of individual values associated with content sponsors for eligible content items that are proposed to be included in the block for a given permutation. A given individual value can be based on a combination of a bid price and a quality score associated with a respective individual eligible content item when included in the block. For example, the content management system 110 can identify eligible content items that are responsive to the request, e.g., based on keywords in the request and/or other selection criteria. From the eligible content items, the content management system 110 can determine different permutations of one or more eligible content items in each permutation. For each permutation, the content management system 110 can determine an efficiency value. Calculation of efficiency values are discussed in greater detail below.

A permutation having the highest efficiency is identified. Thereafter, a price to be charged to each content sponsor having an eligible content item in the permutation (the one having the highest efficiency) is established (206). For example, the content management system 110 can select the permutation that has the highest efficiency. For the selected permutation, the content management system 110 can establish a price for each of the content sponsors 108 associated with the content items that are included in the selected permutation.

Establishing the price can include the following for each position in the determined highest efficiency permutation. A total increase of efficiency can be determined that is associated with all other content sponsors when removing a content sponsor associated with a given position. The total increase of efficiency is based, for example, on content items excluding the content sponsor. For example, equation 2 below is one example way of determining this. A highest efficiency is determined from among the total efficiencies determined, and a price is established for each position based on the determined increase in efficiency, e.g., as shown in equation 4.

In some implementations, determining a total increase in efficiency further includes: determining an efficiency of the determined permutation without a respective content sponsor that is associated with a given position, determining a counterfactual efficiency equal to the highest efficiency permutation that removes a respective eligible content item from the block, and combining the determined efficiency and the determined counterfactual efficiency. For example, the content management system 110 can determine efficiencies as described in more detail below with respect to equations 1-4.

In some implementations, combining the determined efficiency and the determined counterfactual efficiency can include subtracting the determined efficiency from the determined counterfactual efficiency.

In some implementations, determining an efficiency of the determined permutation can include removing a contribution in an efficiency calculation for a respective eligible content item that is associated with a given position of the block. In some implementations, establishing a price can further include dividing the highest possible total increase in efficiency by a quality score associated with a respective eligible content item that is proposed to be presented in a given position. In some implementations, the quality score can include a measure of predicted performance for a given eligible content item when presented in a position included in the block.

The eligible content items associated with the determined permutation are provided responsive to the request, and the content sponsors are charged based on the established prices (208). As an example, the content management system 110 can provide the content items included in the permutation to the user device 106 and charge the content sponsors 108 accordingly.

In some implementations, the process 200 can further include dynamically re-sizing the eligible content items that are associated with the determined highest efficiency permutation. For example, as part of the dynamic allocation process, the content management system 110 can re-size some content items.

In some implementations, the process 200 can further include determining a reserve price that is associated with the block for any content items that are to be included in the block and using the reserve price in establishing the price. For example, the content management system 110 can determine the reserve price r as described in more detail below with respect to equation 8.

In some implementations, establishing the price can include using the reserve price as a floor when calculating efficiency for the highest efficiency permutation, e.g., including using the reserve price instead of a bid price when the bid price is less than the reserve price for a given eligible content item. For example, as described in more detail below with reference to equations 5-8, the reserve price r can be used, as shown in equation 8.

Auctions without Reserve Prices

In auctions without reserve prices, the system and methods can be used to evaluate which content items should be included in a given slot responsive to a request. To better understand the methods proposed, a series of notations are first provided. Let K be a maximum number of eligible content items displayable on a publisher's site. The number of clicks that a content sponsor receives for their content items can be affected both by the total number of content items displayed and the order (in the block or on the web page) in which the content sponsor's content item is displayed. In particular, if a total of k content items are displayed in the block on a publisher's web page, then x_{j,k} represents a measure of a relative number of clicks a content item will receive in position j when there are a total of k content items in the block, where x_{j,k} is non-increasing in j for all k, and x_{j,k}=0 for all j>k and for all k>a. Let bᵢ be a bid placed by a content sponsor i, let qᵢ be content sponsor i's quality score, let q₍ⱼ₎ be a quality score of the eligible content item in the j^{th} position, let a be a number of content sponsors submitting bids in an auction, and let v₍ⱼ₎ be the j^{th} highest value of bᵢqᵢ for all j≦a, where v₍ⱼ₎=0 for all j>a.

In order to achieve truthful bids, a method can be executed for deciding how many content items to display in response to a given request (e.g., how many content items to be displayed in a given block). The method can decide to display a total of k content items, where k is a positive integer in [1,K] that has the highest value of:

Σⱼ₌₁^{k}x_{j,k}v₍ⱼ₎ (1).

The highest value is determined by evaluating permutations of combinations of content items that can be included in a requested block. Initially, content items are ranked. Ranking is discussed in more detail below but takes into account both a bid and a likelihood that the content item will be interacted with once presented. A series of permutations can be evaluated. Initially, a value is computed for a one-item permutation which represents the value associated with having the highest ranked item displayed by itself in the block. Next a permutation of two items is evaluated and a value associated with having the first two items in the ranked list combined in the block is determined. For each permutation, a value is determined for each item included in the permutation, the sum of which represents the overall value of the permutation. The process continues evaluating each permutation for a given number of content items that are to be included in a given block. Ultimately, a number k that represents the number of items that should be included in the block is identified based on a highest value permutation.

In order to determine a price to charge for the display of a particular content item, the method can compute the price in accordance with different efficiencies. The efficiencies can include, for example, a total efficiency for all other content sponsors when removing a content sponsor associated with a given position in a permutation, and a counterfactual efficiency equal to the highest efficiency permutation that removes a respective eligible content item from the block. For example, the counterfactual efficiency, equal to the highest efficiency permutation that removes a respective eligible content item from the block, is given by:

S_{j,K}≡max_{kε[1,K]}Σᵢ₌₁^{j-1}x_{i,k}v₍ᵢ₎+Σᵢ₌ⱼ^{K}x_{i,k}v₍ᵢ₊₁₎ (2).

In addition to using the counterfactual efficiency in determining a price, the efficiency of other content items can be considered, e.g., excluding the content sponsor in question. For example, the total efficiency of other content items for a given permutation is given by:

R_{j,k}≡Σ_{i≠j}x_{i,k}v₍ᵢ₎ (3).

Using the efficiencies S_{j,K} and R_{j,k} computed in equations (2) and (3), for example, the content sponsor associated with the j^{th} position can be charged a total price per click of:

$$\frac{1}{{q}_{( j )} {x}_{j , k}} ( {S}_{j , K} - {R}_{j , k} ) . \qquad ( 4 )$$

In some implementations, the eligible content items can have different quality scores that can depend, for example, on their size, their placement (e.g., in a first position or a lesser position in the block), and the eligible content items can be ranked, in part, on the basis of their quality scores. The number of clicks/interactions that a content sponsor receives can be affected by the total number of content items displayed, the order on the page in which this content sponsor's content item is displayed, and the content item's quality score. In particular, if a total of k content items are displayed on the publisher's site, then the content item in the j^{th} highest position can receive a factor of x_{j,k} as many clicks as the content item would receive if the content item were in the top position on the publisher's site and K content items were displayed.

Auctions with Reserve Prices

The previous example discussed auctions without reserve prices. In some implementations, auctions with reserve prices can use a modified method. Using the modified method can ensure that publishers can specify a minimum price that they are willing to accept for a content item in addition to the objective mentioned earlier (e.g., the truthful bids). In this modified approach, let s denote the maximum number of eligible content items that may ever be displayed on the publisher's site. The number of clicks that a content sponsor receives can be affected both by the total number of content items displayed and the order on the page in which this content sponsor's content item is displayed. In particular, if a total of k content items are displayed on the publisher's site, then x_{j,k} represents a measure of a relative number of clicks a content item will receive in position j when there are a total of k content items in the block, where x_{j,k} is non-increasing in j for all k and x_{j,k}=0 for all j>k and for all k>a.

Let b, denote the bid submitted by content sponsor i, let qᵢ denote content sponsor i's quality score, let r denote a reserve price that gives the minimum value of bᵢqᵢ that a publisher is willing to accept, let a denote the number of content sponsors i who submitted a bid satisfying bᵢqᵢ>r, let K denote the minimum of a and s, and define v₍ⱼ₎ for all j≦K+1 as follows. If a≧s+1, then v₍ⱼ₎ is defined to be the jth highest value of bᵢqᵢ for any of the content sponsors for all j≦s+1. If a<s+1, then define v₍ⱼ₎ to be the jth highest value of bᵢqᵢ any of the content sponsors for all j≦a, and define v₍ₐ₊₁₎ to be equal to r.

A method can be executed for deciding how many content items to display in response to a given request (e.g., how many content items to be displayed in a given block). The method can decide to display a total of k content items, where k is a positive integer in [1,K] that has the highest value of:

Σⱼ₌₁^{k}x_{j,k}v₍ⱼ₎ (5).

As is the case for auctions without reserve prices, the highest value is determined by evaluating permutations of combinations of content items that can be included in a requested block, as described above. However, equation (5) is different from equation (1), as the terms are different to account for reserve auctions. Initially, content items are ranked. Ranking is discussed in more detail below but takes into account both bid and a likelihood that the content item will be interacted with once presented. Thereafter, a series of permutations are evaluated. Initially, a value is computed for a one-item permutation which represents the value associated with having the highest ranked item displayed by itself in the block. Next a permutation of two items is evaluated and a value associated with having the first two items in the ranked list combined in the block is determined. For each permutation, a value is determined for each item included in the permutation, the sum of which represents the overall value of the permutation. The process continues evaluating each permutation for a given number of content items that are to be included in a given block. Ultimately, a number k that represents the number of items that should be included in the block is identified based on a highest value permutation.

In order to determine a price to charge for the display of a particular content item, the method can compute the price in accordance with different efficiencies. The efficiencies can include, for example, a total efficiency for all other content sponsors when ignoring a content sponsor associated with a given position in a permutation, and a counterfactual efficiency equal to the highest efficiency permutation that removes a respective eligible content item from the block. For example, the counterfactual efficiency, equal to the highest efficiency permutation that removes a respective eligible content item from the block, is given by:

S_{j,K}≡max_{kε[1,K]}Σᵢ₌₁^{j-1}x_{i,k}v₍ᵢ₎+Σᵢ₌ⱼ^{K}x_{i,k}v₍ᵢ₊₁₎ (6).

In addition to using the counterfactual efficiency in determining a price, the efficiency of other content items can be considered, e.g., excluding the content sponsor in question. For example, the total efficiency of other content items for a given permutation is given by:

R_{j,k}≡Σ_{i≠j}x_{i,k}v₍ᵢ₎ (7).

Using the efficiencies S_{j,K} and R_{j,k} computed in equations (6) and (7), for example, the content sponsor associated with the jth position can be charged a total price per click of:

$$\frac{1}{{q}_{( j )} {x}_{j , k}} ( {S}_{j , K} - {R}_{j , k} ) . \qquad ( 8 )$$

In this example, q₍ⱼ₎ is a quality score of the eligible content item in the jth position, and x_{j,k} represents a measure of a relative number of clicks a content item will receive in position j when there are a total of k content items in the block.

### Pricing

In some implementations, an auction such as a Vickrey-Clarke-Groves (VCG) auction, can include at least the following two parts: 1) a pairing or allocation of buyers to sellers, and 2) a calculation of the prices that the allocated buyers must pay to obtain the sellers' goods. Example buyers can include content sponsors (e.g., advertisers). Example sellers can include publishers of content blocks or particular portions of content blocks. In this example, goods can be transactions, such as clicks and impressions.

Multiple ways of selecting content items (e.g., one or more advertisements) for a page can be used. In some implementations, a “best allocation” of content items can be selected, and the selected content items can be priced accordingly. Each possible combination of selected content items can be referred to as a configuration, e.g., corresponding to a particular user interface (UI) rendering of a set of content items. The combinations can include a combination, for example, to show three content items, a single content item, and/or to increase the font size of the second content item. A content item can be allocated to particular position or slot in a configuration, where it may or may not receive a particular UI treatment as indicated above.

In some implementations, the quality score owing to position j of configuration k is denoted by xⱼₖ. In general, buyers can “experience” quality differently, e.g., the value vᵢⱼₖ can be used to represent an amount by which buyer i values position j of k. For simplicity, it can be assumed that all buyers value all positions of all configurations linearly, e.g., vᵢⱼₖ=bᵢ xⱼₖ where bᵢ is the bid of buyer i. For simplicity, it can be assumed that the number of positions of configuration k is equal to its index (k). In other words, the quality of all positions greater than k is zero, e.g., xⱼₖ=0 for all j>k. The so-called “efficiency” E of configuration k can be given by:

Σ_{σ}^{(k)}=Σⱼ₌₁^{k}b_{σ(j)}xⱼₖ (9)

where bᵢ denotes a bid and is an ordering or permutation of bids. That is, σ is a mapping from a “position” to an advertiser index.

The “maximum efficiency permutation” can be σ* such that:

Σ_{σ*}^{(k)}≧E_{σ′}^{(k)} (10)

for all possible alternative permutations σ′. The “winning allocation” can be the index of the configuration with the largest maximum efficiency and the associated maximum efficiency permutation, e.g., (k*, σ*) which has the property that:

E_{σ*}^{(k*)}≧E_{σ′}^{(k′)} (11)

for all other σ′, k′.

In some implementations, to calculate VCG prices for advertiser i in the dynamic auction, the following can be determined. What is the total “damage” that content sponsor i has done to all other content sponsors owing to that content sponsor's participation in the auction? That is, what is the change in efficiency to all other buyers as a result of the seller's presence? In some implementations, this can be calculated in two parts. First, a determination can be made of the efficiency of the winning allocation when advertiser i is withheld from participation. This can be termed as the efficiency of the winning “counterfactual allocation”. Second, a determination can be made of the efficiency of all other content sponsors in the winning allocation. This can be termed as the “rest-of-efficiency” of the winning allocation. The efficiency of a winning counterfactual allocation can be given by:

$$E ( i ) = {max}_{σ \backslash \{ i \}} {max}_{k} {E}_{σ}^{( k )} \qquad ( 12 )$$

and the rest-of-efficiency is given by:

R(i)=E_{σ*}^{k*}−bᵢx_{σ*}_{^{−1}}_{(i),k*} (13)

where σ*⁻¹ is a mapping of buyers to positions under the maximum efficiency permutation and k* is the configuration with the largest maximum efficiency.
The total cost buyer i must pay is then:

cost(i)=E(i)−R(i) (14)

and the price-per-click is given by:

$$price\_per \_click ( i ) = \frac{E ( i ) - R ( i )}{pCTR ( i )} \qquad ( 15 )$$

where pCTR(i) is the predicted click-through rate. In this example, buyer i only pays the price-per-click when a click occurs.

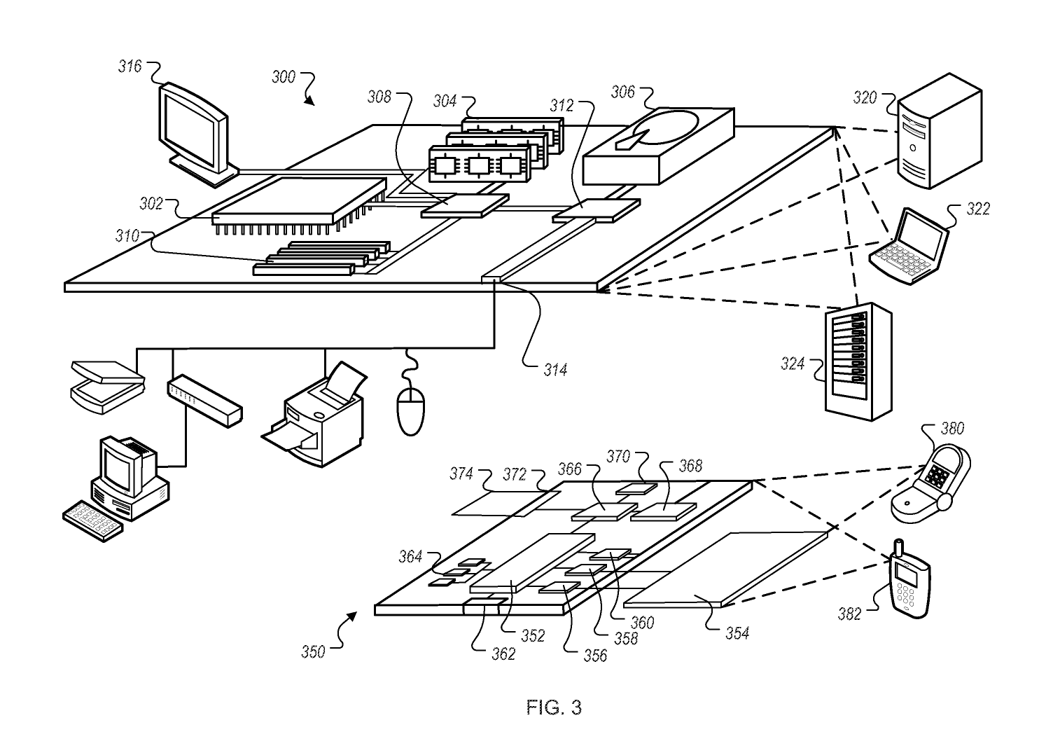

FIG. 3 is a block diagram of example computing devices 300, 350 that may be used to implement the systems and methods described in this document, as either a client or as a server or plurality of servers. Computing device 300 is intended to represent various forms of digital computers, such as laptops, desktops, workstations, personal digital assistants, servers, blade servers, mainframes, and other appropriate computers. Computing device 300 is further intended to represent any other typically non-mobile devices, such as televisions or other electronic devices with one or more processers embedded therein or attached thereto. Computing device 350 is intended to represent various forms of mobile devices, such as personal digital assistants, cellular telephones, smartphones, and other computing devices. The components shown here, their connections and relationships, and their functions, are meant to be examples only, and are not meant to limit implementations of the inventions described and/or claimed in this document.

Computing device 300 includes a processor 302, memory 304, a storage device 306, a high-speed interface 308 connecting to memory 304 and high-speed expansion ports 310, and a low speed interface 312 connecting to low speed bus 314 and storage device 306. Each of the components 302, 304, 306, 308, 310, and 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as display 316 coupled to high speed interface 308. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 304 stores information within the computing device 300. In one implementation, the memory 304 is a computer-readable medium. In one implementation, the memory 304 is a volatile memory unit or units. In another implementation, the memory 304 is a non-volatile memory unit or units.

The storage device 306 is capable of providing mass storage for the computing device 300. In one implementation, the storage device 306 is a computer-readable medium. In various different implementations, the storage device 306 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 304, the storage device 306, or memory on processor 302.

The high speed controller 308 manages bandwidth-intensive operations for the computing device 300, while the low speed controller 312 manages lower bandwidth-intensive operations. Such allocation of duties is an example only. In one implementation, the high-speed controller 308 is coupled to memory 304, display 316 (e.g., through a graphics processor or accelerator), and to high-speed expansion ports 310, which may accept various expansion cards (not shown). In the implementation, low-speed controller 312 is coupled to storage device 306 and low-speed expansion port 314. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. It may also be implemented as part of a rack server system 324. In addition, it may be implemented in a personal computer such as a laptop computer 322. Alternatively, components from computing device 300 may be combined with other components in a mobile device (not shown), such as device 350. Each of such devices may contain one or more of computing device 300, 350, and an entire system may be made up of multiple computing devices 300, 350 communicating with each other.

Computing device 350 includes a processor 352, memory 364, an input/output device such as a display 354, a communication interface 366, and a transceiver 368, among other components. The device 350 may also be provided with a storage device, such as a microdrive or other device, to provide additional storage. Each of the components 350, 352, 364, 354, 366, and 368, are interconnected using various buses, and several of the components may be mounted on a common motherboard or in other manners as appropriate.

The processor 352 can process instructions for execution within the computing device 350, including instructions stored in the memory 364. The processor may also include separate analog and digital processors. The processor may provide, for example, for coordination of the other components of the device 350, such as control of user interfaces, applications run by device 350, and wireless communication by device 350.

Processor 352 may communicate with a user through control interface 358 and display interface 356 coupled to a display 354. The display 354 may be, for example, a TFT LCD display or an OLED display, or other appropriate display technology. The display interface 356 may comprise appropriate circuitry for driving the display 354 to present graphical and other information to a user. The control interface 358 may receive commands from a user and convert them for submission to the processor 352. In addition, an external interface 362 may be provided in communication with processor 352, so as to enable near area communication of device 350 with other devices. External interface 362 may provide, for example, for wired communication (e.g., via a docking procedure) or for wireless communication (e.g., via Bluetooth or other such technologies).

The memory 364 stores information within the computing device 350. In one implementation, the memory 364 is a computer-readable medium. In one implementation, the memory 364 is a volatile memory unit or units. In another implementation, the memory 364 is a non-volatile memory unit or units. Expansion memory 374 may also be provided and connected to device 350 through expansion interface 372, which may include, for example, a subscriber identification module (SIM) card interface. Such expansion memory 374 may provide extra storage space for device 350, or may also store applications or other information for device 350. Specifically, expansion memory 374 may include instructions to carry out or supplement the processes described above, and may include secure information also. Thus, for example, expansion memory 374 may be provide as a security module for device 350, and may be programmed with instructions that permit secure use of device 350. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 364, expansion memory 374, or memory on processor 352.

Device 350 may communicate wirelessly through communication interface 366, which may include digital signal processing circuitry where necessary. Communication interface 366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 368. In addition, short-range communication may occur, such as using a Bluetooth, WiFi, or other such transceiver (not shown). In addition, GPS receiver module 370 may provide additional wireless data to device 350, which may be used as appropriate by applications running on device 350.

Device 350 may also communicate audibly using audio codec 360, which may receive spoken information from a user and convert it to usable digital information. Audio codec 360 may likewise generate audible sound for a user, such as through a speaker, e.g., in a handset of device 350. Such sound may include sound from voice telephone calls, may include recorded sound (e.g., voice messages, music files, etc.) and may also include sound generated by applications operating on device 350.

The computing device 350 may be implemented in a number of different forms, as shown in the figure. For example, it may be implemented as a cellular telephone 380. It may also be implemented as part of a smartphone 382, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a request for content to fill a block, the request including information about a size of the block and selection criteria for identifying one or more eligible content items for inclusion in the block;
determining a variable number of content items to be included in the block, including determining an efficiency for each of a number of permutations of allocations of eligible content items, wherein the efficiency is a summation of individual values associated with content sponsors that are proposed to be included in the block for a given permutation, and wherein a given individual value is based on a combination of a bid price and a quality score associated with a respective individual eligible content item when included in the block;
establishing a price to be charged to each content sponsor associated with a permutation that has a highest efficiency based on the determining, the establishing including, for each position in a determined highest efficiency permutation:
determining a total increase of efficiency associated with all other content sponsors when removing a content sponsor associated with a given position, the total increase of efficiency being based on content items excluding the content item associated with the excluded content sponsor;
determining a highest efficiency from among the total efficiencies determined; and
establishing a price for each position based on the determined increase in efficiency; and
providing the eligible content items associated with the determined permutation responsive to the request and charging the content sponsors based on the established prices.

2. The method of claim 1 wherein determining a total increase in efficiency further includes:
determining an efficiency of the determined permutation without a respective content sponsor that is associated with a given position;
determining a counterfactual efficiency equal to the highest efficiency permutation that removes a respective eligible content item from the block; and
combining the determined efficiency and the determined counterfactual efficiency.

3. The method of claim 2 wherein combining includes subtracting the determined efficiency from the determined counterfactual efficiency.

4. The method of claim 1, wherein determining an efficiency of the determined permutation includes removing a contribution in an efficiency calculation for a respective eligible content item that is associated with a given position of the block.

5. The method of claim 1, wherein the eligible content items are advertisements.

6. The method of claim 1 further comprising dynamically re-sizing the eligible content items that are associated with the determined highest efficiency permutation based at least in part on a value to a respective sponsor for inclusion of their content item in the block.

7. The method of claim 1 further comprising determining a reserve price that is associated with the block for any content items that are to be included in the block and using the reserve price in establishing the price.

8. The method of claim 7, wherein establishing the price includes using the reserve price as a floor when calculating efficiency for the highest efficiency permutation.

9. The method of claim 8, wherein using the reserve price as a floor includes using the reserve price instead of a bid price when the bid price is less than the reserve price for a given eligible content item.

10. The method of claim 1, wherein establishing a price further includes dividing the highest efficiency by a quality score associated with a respective eligible content item that is proposed to be presented in a given position.

11. The method of claim 10, wherein the quality score includes a measure of predicted performance for a given eligible content item when presented in a position included in the block.

12. The method of claim 1, wherein, in a mechanism for providing a total of k eligible content items in the block, the efficiency for a given permutation is given by:
Σⱼ₌₁^{k}x_{j,k}v₍ⱼ₎
and wherein the pricing for a given j^{th} position is given by:
$$\frac{1}{{q}_{( j )} {x}_{j , k}} ( {S}_{j , K} - {R}_{j , k} )$$
wherein:
K is a maximum number of eligible content items displayable on a publisher's site;
bᵢ is a bid placed by a content sponsor i;
qᵢ is a quality score of content sponsor i;
q₍ⱼ₎ is a quality score of the eligible content item in the j^{th} position;
S_{j,K}≡max_{kε[1,K]}Σᵢ₌₁^{j-1}x_{i,k}v₍ᵢ₎+Σᵢ₌ⱼ^{K}x_{i,k}v₍ᵢ₊₁₎, wherein x_{j,k} represents a measure of a relative number of interactions a content item will receive in position j when there are a total of k content items in the block, wherein x_{j,k} is non-increasing in j for all k, and wherein x_{j,k}=0 for all j>k and all k>a;
v₍ⱼ₎ is the j^{th} highest value of bᵢqᵢ for all j≦a, wherein vⱼ=0 for all j>a;
a is a number of content sponsors submitting bids in an auction;
k is a positive integer in [1,K] that has the highest value of Σⱼ₌₁^{k}x_{j,k}v₍ⱼ₎;
j is a position value for which the mechanism is to decide to provide the eligible content item with the j^{th} highest value of bᵢqᵢ in the j^{th} highest of available positions; and:
R_{j,k}≡Σ_{i≠j}x_{j,k}v₍ᵢ₎.

13. A computer program product embodied in a tangible medium including instructions, that when executed, cause one or more processors to:
receive a request for content to fill a block, the request including information about a size of the block and selection criteria for identifying one or more eligible content items for inclusion in the block;
determine a variable number of content items to be included in the block, including determining an efficiency for each of a number of permutations of allocations of eligible content items, wherein the efficiency is a summation of individual values associated with content sponsors that are proposed to be included in the block for a given permutation, and wherein a given individual value is based on a combination of a bid price and a quality score associated with a respective individual eligible content item when included in the block;
establish a price to be charged to each content sponsor associated with a permutation that has a highest efficiency based on the determining, the establishing including, for each position in a determined highest efficiency permutation:
determine a total increase of efficiency associated with all other content sponsors when removing a content sponsor associated with a given position, the total increase of efficiency being based on content items excluding the content item associated with the excluded content sponsor;
determine a highest efficiency from among the total efficiencies determined; and
establish a price for each position based on the determined increase in efficiency; and
provide the eligible content items associated with the determined permutation responsive to the request and charging the content sponsors based on the established prices.

14. The computer program product of claim 13, wherein the eligible content items are advertisements.

15. The computer program product of claim 13 further comprising instructions, that when executed, cause the one or more processors to dynamically re-size the eligible content items that are associated with the determined highest efficiency permutation based at least in part on a value to a respective sponsor for inclusion of their content item in the block.

16. The computer program product of claim 13 further comprising instructions, that when executed, cause the one or more processors to determine a reserve price that is associated with the block for any content items that are to be included in the block and use the reserve price in establishing the price.

17. A system comprising:
one or more processors; and
one or more memory elements including instructions that, when executed, cause the one or more processors to:
receive a request for content to fill a block, the request including information about a size of the block and selection criteria for identifying one or more eligible content items for inclusion in the block;
determine a variable number of content items to be included in the block, including determining an efficiency for each of a number of permutations of allocations of eligible content items, wherein the efficiency is a summation of individual values associated with content sponsors that are proposed to be included in the block for a given permutation, and wherein a given individual value is based on a combination of a bid price and a quality score associated with a respective individual eligible content item when included in the block;
establish a price to be charged to each content sponsor associated with a permutation that has a highest efficiency based on the determining, the establishing including, for each position in a determined highest efficiency permutation:
determine a total increase of efficiency associated with all other content sponsors when removing a content sponsor associated with a given position, the total increase of efficiency being based on content items excluding the content item associated with the excluded content sponsor;
determine a highest efficiency from among the total efficiencies determined; and
establish a price for each position based on the determined increase in efficiency; and
provide the eligible content items associated with the determined permutation responsive to the request and charging the content sponsors based on the established prices.

18. The system of claim 17, wherein the eligible content items are advertisements.

19. The system of claim 17 further comprising instructions that, when executed, cause the one or more processors to dynamically re-size the eligible content items that are associated with the determined highest efficiency permutation based at least in part on a value to a respective sponsor for inclusion of their content item in the block.

20. The system of claim 17 further comprising instructions that, when executed, cause the one or more processors to determine a reserve price that is associated with the block for any content items that are to be included in the block and use the reserve price in establishing the price.
